(19) United States
(12) Patent Application Publication
(10) Pub. No.: US 2009/0004086 A1
(43) Pub. Date: Jan. 1, 2009

(54) Thermoelectric Nanomaterials

(75) Inventors: Klaus Kuhling, Ellerstadt (DE); Martin Graeser, Kunzell (DE); Joachim H. Wendorff, Marburg (DE); Andreas Greiner, Amoneburg (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/159,408

(22) PCT Filed: Nov. 30, 2006
(86) PCT No.: PCT/EP2006/069116

§ 371 Date: Jun. 27, 2008

(30) Foreign Application Priority Data
Dec. 29, 2005 (DE) 10 2005 063 038.3

(51) Int. Cl. C01B 35/08

(52) U.S. Cl. 423/276; 264/465; 423/508; 977/742; 977/762

(57) ABSTRACT

The present invention relates to processes for producing nanowires and nanotubes by treating a fiber comprising at least one support material and at least one thermoelectrically active material or a precursor compound of a thermoelectrically active material, to a nanowire comprising at least one thermoelectrically active material and having a diameter of ≦200 nm and a length of ≧1 mm, to nanotubes comprising at least one thermoelectrically active material and having a diameter of ≦200 nm, a wall thickness of ≦30 nm and a length of ≧1 mm, and to the use of the nanowires or nanotubes for thermoelectric heating, for electricity generation, in sensors or for temperature control.

The present invention relates to processes for preparing nanowires or nanotubes by electrospinning melts or solutions of suitable support materials which, if appropriate, comprise thermoelectric materials, to nanowires and nanotubes, and to the use of these nanowires and nanotubes for thermoelectric heating, for current generation, in sensors or for thermal control.

In the field of thermoelectric energy conversion, the search for novel thermoelectrically active materials with high efficiency is of great significance. The properties of thermoelectric materials are summarized in the so-called figure of merit Z, usually expressed as the dimensionless parameter ZT. This parameter ZT has to be maximized in order to achieve a maximum efficiency.

ZT=S²σT/λ
S: Seebeck coefficient, μV/K
σ: electrical conductivity, S/cm
T: temperature in K
A: thermal conductivity, W/(m K)

Since the discovery of Bi₂Te₃ as a particularly favorable material for cooling applications over 50 years ago, the maximum ZT value achieved has stagnated at about 1. From a ZT value of >2, thermoelectric systems would be able to compete with conventional techniques, for example for climate control. The sectors of use and fields of application for thermoelectrics depend directly upon the parameter ZT.

In nanostructured materials, quantum effects occur, which enable separation of electron and phonon scattering and thus a reduction in the thermal conductivity with substantial retention of the electrical conductivity. In this field, the classical relationship based on Wiedemann-Franz, according to which the electrical conductivity is directly proportional to the thermal conductivity, applies only in a restricted manner:

λ/σ=aT
σ: electrical conductivity, S/cm
T: temperature, K
λ: thermal conductivity, W/(m K)
a: proportionality factor

In theoretical considerations, a ZT value of up to ZT=6 is discussed for one-dimensional structures, for example of bismuth, the so-called nanowires. These are wires with a diameter of approx. 10 nm.

Experimental studies in this order of magnitude are very difficult by their nature. Few processes for producing nanowires are known.

Physical Review Letters, Volume 88, No. 21, pages 216801-1 to 216801-4 discloses a process for producing bismuth nanowires. To this end, molten bismuth is introduced under high pressure into the pores of appropriate templates made of Al₂O₃ or silica gel. The thickness of the bismuth wires which can be prepared by this process is restricted to greater than 40 to 50 nm by virtue of the process. Additionally disclosed is a process for producing nanowires with a diameter of 7 nm by vapor deposition from corresponding molds made of silica gel. In this process too, the length of the wires is restricted.

Thermoelectric Material 2003, Research and Applications, pages 3 to 14 discloses a process for producing nanowires with diameters of from 4 to 200 nm. These wires are produced by depositing metals such as bismuth, antimony and zinc in molds made of electrically nonconducting materials such as Al₂O₃ or SiO₂. The deposition is carried out in such a way that the metals are evaporated in a vacuum chamber, and the corresponding metal vapors are precipitated in the tubular channels of the molds.

Eur. J. Inorg. Chem., 2003, 3699 to 3702 discloses a process for producing arrays in which a number of bismuth nanotubes are arranged in parallel. To this end, an aqueous solution of BiCl₃ is reduced with zinc powder. After removal of the excess zinc powder, a black powder remains, in which nanotubes of bismuth are arranged in parallel to one another.

An overview of the processes known to date for producing nanowires is given by Adv. Mater. 2003, 15, No. 5, pages 353-389. The processes disclosed comprise the deposition of metals from the vapor phase in appropriately dimensioned molds of porous material, the introduction of solutions or melts of appropriate compounds, if appropriate under high pressure, into said molds, or the self-arrangement of nanoparticles to give nanowires or -tubes.

Angew. Chem. 2004, 116, 1356 to 1367 discloses a process for producing nanotubes by wetting appropriately shaped templates with solutions of the materials of which the nanotubes consist.

The processes mentioned have the disadvantage that, to align the nanowires, the shaping matrix has to be preserved. It is therefore impossible to obtain free nanowires in experimentally advantageous lengths by the known processes. The presence of the shaping matrix has an adverse effect on the thermal conductivity. The absolute achievable length of the nanowires is short, for example up to 100 μm. In addition, the deposition of the material from the gas phase in extremely narrow channels can lead to blockages of the channels, so that the nanowires formed are not continuous. The contacting for experimental or application purposes of the short nanowires embedded into the matrix is difficult. Therefore, control via the number of actually contacted wires and the test results thus achieved is problematic.

Polymer fibers with a diameter in the nanometer range can be obtained by the electrospinning method.

Adv. mater. 2004, 16, No. 14, pages 1151-1169 discloses a process for producing nanofibers by electrospinning a great variety of suitable materials, for example various polymers and copolymers, Al₂O₃, CuO, NiO, TiO₂—SiO₂, V₂O₅, ZnO, Co₃O₄, Nb₂O₅, MoO₃ and MgTiO₃. To this end, a melt or solution of the appropriate material is sprayed through a fine electrically charged nozzle, for example the tip of a syringe, in the direction of an oppositely charged or grounded plate. The electrostatic attraction of the charged melt or solution accelerates the beam so greatly that it narrows to a diameter in the nanometer range. By the time the material beam hits the opposite pole, solvent present has evaporated or the melt has cooled to such an extent that it has solidified again. Thus, a theoretically endless thread with a diameter in the nanometer range can be obtained.

DE 101 16 232 A1 discloses a process for producing internally coated hollow fibers with an internal diameter of the cavities or of the hollow fibers with an internal diameter of up to 100 to 500 nm. The length of the fibers produced by this process is from 50 μm up to several mm or cm. A fiber with a diameter in the nanometer range is obtained in an electrospinning process from a solution or melt of a first material selected from degradable inorganic or organic materials, especially polymers, in a mixture with a second material selected from catalytically active materials from groups Ia, Ib, IIa, IIb, IIIa, IIIb, IVa, IVb; Vb, VIb, VIIb, and/or VIIIb of the Periodic Table of the Elements. This fiber is coated with a third non-degradable material. After removal of the first, degradable material by suitable methods, a hollow fiber of the third, nondegradable material which is coated on the inner side with the second, catalytically active material is obtained.

It is an object of the present invention to provide a process by which nanowires and nanotubes which comprise at least one thermoelectrically active material and have a sufficient length can be produced, so that the above-mentioned disadvantages with regard to handling and contacting can be avoided. It is a further object of the present invention to provide a simple and inexpensive process by which nanowires and nanotubes which comprise at least one thermoelectrically active material are obtained in sufficient amount and in uniform quality.

The object is achieved by a process for producing nanowires by treating a fiber comprising at least one support material and at least one thermoelectrically active material or a precursor compound of a thermoelectrically active material, comprising:
(A) providing a melt or solution which comprises at least one support material or suitable precursor compounds of the support material and at least one thermoelectrically active material or a precursor compound of a thermoelectrically active material,
(B) electrospinning the melt or solution from step (A) to obtain a fiber comprising at least one support material and at least one thermoelectrically active material or a precursor compound of a thermoelectrically active material,
(C) if appropriate enveloping the fiber obtained with an electrical nonconductor to obtain an electrically insulated fiber,
(D) if appropriate converting the precursor compound of the thermoelectrically active material to the active form,
(E) if appropriate removing the support material, steps (C) to (E) being performable in any sequence.

The object is also achieved by a process for producing nanotubes by treating a fiber comprising at least one support material and at least one thermoelectrically active material or a precursor compound of a thermoelectrically active material, comprising:
(F) providing a melt or solution which comprises at least one support material or suitable precursor compounds of the support material,
(G) electrospinning the melt or solution from step (F) to obtain a fiber of at least one support material,
(H) enveloping the fiber obtained in step (G) with at least one thermoelectrically active material or a precursor of a thermoelectrically active material to obtain a fiber comprising at least one support material and at least one thermoelectrically active material or a precursor compound of a thermoelectrically active material,
(I) if appropriate enveloping the fiber obtained with an electrical nonconductor to obtain an electrically insulated fiber,
(J) if appropriate converting the precursor compound of the thermoelectrically active material to the active form,
(K) if appropriate removing the support material, steps (I) to (K) being performable in any sequence.

The process for producing nanowires and the process for producing nanotubes both comprise the treatment of a fiber comprising at least one support material and at least one thermoelectrically active material or a precursor compound of a thermoelectrically active material.

The individual steps are illustrated in detail hereinbelow:

### Step (A):

Step (A) of the process according to the invention for producing nanowires comprises the provision of a melt or solution which comprises at least one support material or suitable precursor compounds of the support material and at least one thermoelectrically active material or a precursor compound of a thermoelectrically active material.

In a preferred embodiment, the support material is a polymer or a material which is obtained by the sol-gel process. In a particularly preferred embodiment, the support material is a polymer. When the support material is obtained by the sol-gel process, a solution of suitable precursor compounds is used in step (A).

Suitable polymers which can be used in the process according to the invention for producing nanofibers are all known homopolymers and copolymers consisting of at least two different monomers which can be spun by the electrospinning process.

Preference is given here to polymers selected from the group consisting of polyesters, polyamides, polyimides, polyethers, polyolefins, polycarbonates, polyurethanes, natural polymers, polylactides, polyglycosides, poly-α-methylstyrene, polymethacrylates, polyacrylonitriles, latices, polyalkylene oxides formed from ethylene oxide and/or propylene oxide, and mixtures thereof. The polymer is more preferably a polylactide or a polyamide.

The polymer usable in accordance with the invention is preparable by processes known to those skilled in the art or commercially available.

When a solution of the abovementioned polymers is used to prepare nanofibers in step (A) of the process according to the invention, this solution may comprise all solvents or mixtures of solvents. These are preferably evaporable at a temperature of less than 160° C., more preferably less than 110° C. at standard pressure, and the thermoelectrically active materials or their precursor compounds are at least partly soluble therein.

In general, a solvent is used which is selected from the group consisting of chlorinated solvents, for example dichloromethane or chloroform, acetone, ethers, for example diethyl ether, methyl tert-butyl ether, hydrocarbons having fewer than 10 carbon atoms, for example n-pentane, n-hexane, cyclohexane, heptane, octane, dimethyl sulfoxide (DMSO), N-methylpyrrolidinone (NMP), dimethylformamide (DMF), formic acid, water, liquid sulfur dioxide, liquid ammonia and mixtures thereof. The solvent used is preferably one selected from the group consisting of dichloromethane, acetone, formic acid and mixtures thereof.

In the process according to the invention, the support material can also be obtained by the sol-gel process. To this end, a solution of suitable precursor compounds of the support material is used in step (A).

In the sol-gel process, the preparation, i.e. deposition, of the materials starts in each case from a liquid sol state which is converted to a solid gel state by a sol-gel transformation. Sols refer to dispersions of solid particles in the size range between 1 nm and 100 nm which are present in ultrafine distribution (dispersion) in water or organic solvents. Sol-gel processes generally start from sol systems based on organometallic polymers. The transition from the liquid sol to the ceramic material is effected in each case via a gel state. During the sol-gel transformation, there is three-dimensional crosslinking of the nanoparticles in the solvent, as a result of which the gel receives solid state properties. The gel is converted to a ceramic material by controlled treatment under air. This treatment is carried out in the present process during the spinning of the fibers. Suitable sol-gel systems are mentioned, for example, in “Das Sol-Gel-Verfahren, H. K. Schmidt, Chemie in unserer Zeit, 35, 2001, No. 3, p. 176 to 184”.

In step (A) of the process according to the invention for producing nanofibers, the abovementioned support material is mixed with a thermoelectrically active material or a precursor compound of a thermoelectrically active material.

In a preferred embodiment, the thermoelectrically active material is at least one compound comprising at least one element selected from the group consisting of tellurium, antimony, silicon, boron and germanium, and/or the thermoelectrically active material is selected from the group consisting of oxides, skutterudites, clathrates and bismuth.

Examples of suitable oxides are cobalt oxides with a layer lattice such as NaCo₂O₄ or Bi₂₋ₓPbₓSr₂Co₂O_{y} where x=from 0 to 0.6 and y=8+σ, from “Chemistry, Physics and Material Science of Thermoelectric Materials Beyond Bismuth Tellurides”, Kluwer Academic/Plenum Publishers, New York 2003, pages 71 to 87. Additionally suitable are whiskers based on Cu—Co—O or Bi—Sr—Co—O. Additionally particularly suitable as thermoelectrically active materials based on oxides are mixed oxides of the general formula (I)

SrTiOₘSₙ (I)

where
0≦n≦0.2 and
2≦m≦2.99, in particular 2≦m≦2.5.

Suitable oxides are disclosed in R. Funahashi et al., Jpn. J. Appl. Phys. Vol. 39 (2000), for example Ca₂CoO₂O₅, NaCo₂O₄ or Ca₂Co₄O₉.

Examples of suitable tellurides are tellurides based on bismuth tellurides and lead tellurides, for example Bi₂Te₃ or PbTe. Thermoelectrically active materials based on bismuth tellurides or lead tellurides may additionally be doped. Suitable elements for doping are selected from main group 3 or 5 of the Periodic Table of the Elements, in the amounts known to those skilled in the art. Processes for doping the compounds mentioned are known to those skilled in the art.

An example of a suitable antimonide is Zn₄Sb₃. Antimonides are preferably used in the moderate temperature range, i.e. at temperatures of from 100 to 400° C.

Examples of suitable silicides are FeSi₂ and modifications thereof. Owing to their particular stability, silicides are used preferentially in applications from the space travel sector.

Examples of suitable borides are B₄C and CaB₆ or SrB₆, and modifications thereof. The borides mentioned may also be doped with suitable elements. Suitable elements for doping are selected from main group 3 or 5 of the Periodic Table of the Elements in the amounts known to those skilled in the art.

The borides feature a low density. They are therefore preferably used in applications in which a low density of the thermoelectrically active material is a crucial factor.

One example of suitable germanides is that of silicon/germanium alloys. These alloys are particularly suitable for applications in the high-temperature sector, i.e. temperatures above 500° C.

Examples of suitable skutterudites are disclosed in Chemistry, Physics and Material Science of Thermoelectric Materials, Kluwer Academic/Plenum Publishers, New York, pages 121-146, for example CoSb₃, Fe_{0.5}Ni_{0.5}Sb₃.

Examples of suitable clathrates are in Chemistry, Physics and Material Science of Thermoelectric Materials, Kluwer Academic/Plenum Publishers, New York, pages 107-121, for example type I: X₂E₄₆, e.g. Sr₈Ga₁₆Ge₃₀, or type II: X₈Y₁₆E₁₃₆, e.g. Cs₈Na₁₆Si₁₃₆, Cs₈Na₁₆Ge₁₃₆.

In a preferred embodiment, the thermoelectrically active material is selected from the group consisting of bismuth, Bi₂Te₃, PbTe and mixtures thereof.

The thermoelectrically active materials usable in accordance with the invention are preparable by processes known to those skilled in the art or commercially available.

It is possible in step (A) of the process according to the invention to introduce the thermoelectrically active materials into the melt or solution as such or in the form of suitable precursor compounds. Suitable precursor compounds are all compounds, complexes or mixtures which can be converted to the thermoelectrically active materials by chemical and/or physical methods.

In a preferred embodiment, the precursor compound for the thermoelectrically active material is a salt or a complex of the thermoelectrically active material.

In step (A), the at least one thermoelectrically active material or the precursor compound of the thermoelectrically active material with the at least one support material or suitable precursor compounds of the support material can be provided in solution or as a melt.

To prepare a solution of at least one thermoelectrically active material or a precursor compound of the thermoelectrically active material and at least one support material or suitable precursor compounds of the support material, preferably of at least one polymer, all processes known to those skilled in the art may be used. A solution of the at least one support material can be mixed with a solution of the thermoelectrically active material or a precursor compound, in which case the same or different solvents may be used, which are selected from the aforementioned group of solvents or solvent mixtures. The mixing can be carried out with stirring, under the action of ultrasound or under the action of heat. Suitable reactors are known to those skilled in the art. The concentration of the at least one polymer in the solution is generally at least 0.1% by weight, preferably from 1 to 30% by weight, more preferably from 2 to 20% by weight. The ratio of the mass of the thermoelectrically active substance or of a precursor compound of the thermoelectrically active substance to the mass of the polymer is generally up to 10:1, preferably from 1:1 to 3:1.

When a melt is used in step (A), it can be prepared by all processes known to those skilled in the art. An example of this is heating to a temperature above the melting point or the glass transition temperature of the polymer or of the polymer mixture, preferably at least 10° C., more preferably at least 30° C., most preferably at least 50° C. above the melting point. In a preferred embodiment, the melting is carried out under reduced pressure or in a protective gas atmosphere, preferably in an atmosphere comprising nitrogen and/or a noble gas, for example argon.

When the support material used in step (A) of the process according to the invention is a polymer, the thermoelectrically active substance or a precursor compound of the thermoelectrically active substance may be bonded covalently to the polymer chain. Polymers which have thermoelectrically active substances or precursor compounds thereof in covalently bonded form may be obtained by polymerization of monomers to which the substances are already bonded covalently. The advantage of this procedure is that the thermoelectrically active substance or its precursor compound is distributed particularly uniformly over the polymer, and hence the fibers. Suitable processes are described, for example, in J. Am. Soc. 1992, 114, 7295-7296, Chem. Mater. 1992, 4, 24-27 and Chem. Mater. 1992, 4, 894-899.

### Step (B):

Step (B) of the process according to the invention for producing nanowires comprises the electrospinning of the melt or solution from step (A) to obtain a fiber comprising at least one support material, preferably at least one polymer, and at least thermoelectrically active material or a precursor compound of a thermoelectrically active material.

The electrospinning process is known to those skilled in the art, for example from Adv. Mater. 2004, 16, No. 14, pages 1151 to 1169. To this end, the solution or melt provided in step (A) of the process according to the invention is generally pumped through a fine nozzle which has an electrical charge, so as to result in a fine jet of solution or melt. Instead of a nozzle, it is also possible to use other geometries known to those skilled in the art. The apparatus for spinning comprises, opposite the nozzle, a collector which, based on the nozzle, is oppositely charged or grounded, so that the jet charged by the nozzle is attracted by the collector. In general, a voltage of from 5 kV to 100 kV, preferably from 10 kV to 50 kV, is applied. A suitable distance between the nozzle and the collector is known to the person skilled in the art. The resulting electrical field accelerates the particles present in the jet of solution or melt, so that this acceleration narrows the jet so greatly that it has a diameter in the nanometer range. The collector is generally designed in such a way that the nanowire which has solidified as a result of evaporation of the solvent or as a result of cooling to a temperature below the melting point can be wound up or collected by a suitable method.

When a polymer melt is used in step (A), the temperature of this melt before it leaves the spinning nozzle is at least 10° C., preferably at least 30° C., more preferably at least 50° C. above the melting point or TG of the homo- or copolymer used.

The electrospinning affords a fiber comprising at least one support material, preferably at least one polymer, and at least one thermoelectrically active material or a precursor compound of a thermoelectrically active material.

The electrospinning may be followed, if appropriate, by washing and cleaning steps. In general, cleaning of the fibers obtained is not necessary.

The electrospinning of the solution or melt provided in step (A) and comprising at least one support material or suitable precursor compounds of the support material and at least one thermoelectrically active material or a precursor compound of a thermoelectrically active material in step (B) of the process according to the invention affords a fiber which comprises at least one support material, preferably a polymer, and at least one thermoelectrically active material or a precursor compound of a thermoelectrically active material.

The length of the fiber obtained in step (B) is in principle not restricted. By virtue of the continuous process, fibers of any length are obtainable.

In a preferred embodiment, the nanofiber produced is wound up on a drum. When the drum is covered at least once by the nanofiber over the entire width, the spinning operation can be interrupted, and the nanofibers can be cut through at right angles to the fiber and along the drum, so as to obtain a parallel arrangement of a multitude of nanofibers whose length corresponds to the circumference of the drum.

In a further preferred embodiment, instead of the drum, it is also possible to use a metal frame, onto which the fibers produced can be wound up. In this embodiment, a parallel arrangement of the fibers arises automatically. Such a procedure is disclosed, for example, in R. Dersch et al., J. Polym. Sci. Part A: Pol. Chem., Vol. 41, 545-553, 2003.

The thickness of an individual fiber obtained in step (B) is less than 200 nm, preferably less than 50 nm, more preferably less than 20 nm.

### Step (C):

The optional step (C) of the process according to the invention for producing nanowires comprises the enveloping of the fiber obtained in step (B) with an electrical nonconductor to obtain an electrically insulated fiber.

To envelop the nanofiber which comprises at least one support material, preferably a polymer, and at least thermoelectrically active material or a precursor compound of a thermoelectrically active material, all processes known to those skilled in the art may be used.

Examples include gas phase deposition, sputtering, spin-coating, dip-coating, spraying or plasma deposition. Preference is given to the application of a non-conducting material by impregnating or spraying the nanofiber from step (B) with or in a solution of the electrically nonconducting material and subsequent removal of the solvent, for example by heating, if appropriate under reduced pressure. Suitable solvents are all solvents in which the electrically nonconducting material dissolves readily, but the at least one support material which has been provided in step (A) dissolves poorly.

In step (C) of the process according to the invention, all electrical nonconductors known to the person skilled in the art can be used.

In a preferred embodiment, the electrical nonconductor is selected from aromatic and aliphatic homo- and copolymers and mixtures thereof.

When the electrical nonconductor used is a homo- or copolymer, this material can also be applied to the nanofiber from step (B) in such a way that the corresponding monomers are polymerized in the presence of the fiber, so that the polymer or copolymer formed in situ is deposited on the fiber.

Particular preference is given to the polymers or copolymers selected from the group consisting of poly(p-xylylene), polyacrylamide, polyimides, polyesters, polyolefins, polycarbonates, polyamides, polyethers, polyphenyls, polysilanes, polysiloxanes, polybenzimidazoles, polybenzothiazoles, polyoxazoles, polysulfides, polyesteramides, polyarylenevinylenes, polylactides, polyether ketones, polyurethanes, polysulfones, ormocers, polyacrylates, silicones, fully aromatic copolyesters, poly-N-vinylpyrrolidone, polyhydroxyethyl methacrylate, polymethyl methacrylate, polyethylene terephthalate, polybutylene terephthalate, polymethacrylonitrile, polyacrylonitrile, polyvinyl acetate, neoprene, Buna N, polybutadiene, polytetrafluoroethene, modified or unmodified cellulose, alginates or collagen, their homo- or copolymers and mixtures thereof.

Polymers mentioned are preparable by processes known to those skilled in the art or commercially available.

The electrical nonconductor is more preferably poly(p-xylylene) or polytetrafluoroethene.

The electrical nonconductor is preferably brought onto the fiber by gas phase deposition.

In the context of the present invention, enveloping means that the fiber obtained in step (B) is enveloped by an electrical nonconductor to an extent of at least 70%, preferably to an extent of at least 80%, more preferably to an extent of at least 90%.

When the optional step (C) of the process according to the present invention is not carried out, the process according to the invention affords a nanowire which is not electrically insulated on the exterior.

### Step (D):

The optional step (D) of the process according to the invention comprises the conversion of the precursor compound of the thermoelectrically active material to the active form.

Step (D) of the process according to the invention has to be carried out when a precursor compound of a thermoelectrically active material in a mixture with at least one polymer is used in step (A).

The precursor compound can be converted to the thermoelectrically active form by all methods known to those skilled in the art.

When the thermoelectrically active material in the 0 oxidation state is present in a complex, it can be converted by processes known to those skilled in the art to free, uncomplexed thermoelectrically active material. One example is the reaction of these complexes with other metals or metal cations which form a more stable complex with the complex ligands of the thermoelectrically active material than the corresponding complex of the thermoelectrically active material.

When the precursor compounds of the thermoelectrically active material used are salts or complexes in which the thermoelectrically active material is present in a higher oxidation state, the precursor compounds can be converted to the thermoelectrically active material by reduction. The reduction can be carried out by electrochemical or wet chemical methods. Suitable reducing agents are hydrides, base metals such as zinc, and hydrogen, the reduction of the precursor compounds of the thermoelectrically active compounds with gaseous hydrogen being a preferred embodiment of the process according to the invention.

In a preferred embodiment of the process according to the invention for producing nanowires, the precursor compound of the thermoelectrically active compound used in step (A) is a salt of bismuth, more preferably bismuth trichloride. These compounds of bismuth can be converted to the thermoelectrically active material bismuth by reduction with hydrogen.

The reduction is generally carried out by processes known to those skilled in the art, and is preferably carried out in pure hydrogen at a temperature of at least 250° C. and for at least 20 min.

### Step (E):

The optional step (E) comprises the removal of the support material, preferably of the polymer, which is used in step (A).

Suitable processes for removing the support material, preferably the polymer, are known to those skilled in the art. Examples include thermal, chemical, radiation-induced, biological, photochemical processes, and also processes by means of plasma, ultrasound, hydrolysis or by extraction with a solvent. Preference is given to solvent extraction or thermal degradation. Depending on the material, the decomposition conditions are at 10-500° C. and from 0.001 mbar to 1 bar. The removal can be effected fully or in a proportion of at least 70%, preferably at least 80%, more preferably at least 90%.

The removal of the support material affords a nanowire which comprises thermoelectrically active material exclusively or in the above-mentioned proportions.

It is also possible in accordance with the invention that the support material added in step (A) is not removed, so that a nanowire is obtained which comprises, in addition to at least one thermoelectrically active material, at least one support material, preferably at least one polymer.

Steps (C), (D) and (E) are optional, i.e. it is possible for no, one, two or three of the three steps to be carried out.

Moreover, the sequence of steps (C), (D) and (E) is as desired. This means that, for example after step (B), it is possible to carry out step (C), (D) and/or (E).

The reason for the different sequence of steps (C), (D) and (E) may be that different support materials and/or thermoelectrically active materials cause different sequences of the process steps mentioned. For example, it may be advisable that the support material removal in step (E) is carried out before the enveloping of the fiber obtained in step (B) with an electrical nonconductor (step (C)). Moreover, it is possible that the conversion of the precursor compound of the thermoelectrically active material (step (D)) is carried out after the removal of the support material (E)).

In a preferred embodiment, the steps of the process according to the invention for producing nanowires are carried out in the sequence (A), (B), (C), (D), (E).

The present invention also relates to a process for producing nanotubes by treating a fiber comprising at least one support material and at least one thermoelectrically active material or a precursor compound of a thermoelectrically active material, comprising:
(F) providing a melt or solution which comprises at least one support material or suitable precursor compounds of the support material,
(G) electrospinning the melt or solution from step (F) to obtain a fiber of at least one support material,
(H) enveloping the fiber obtained in step (G) with at least one thermoelectrically active material or a precursor of a thermoelectrically active material to obtain a fiber comprising at least one support material and at least one thermoelectrically active material or a precursor compound of a thermoelectrically active material,
(I) if appropriate enveloping the fiber obtained with an electrical nonconductor to obtain an electrically insulated fiber,
(J) if appropriate converting the precursor compound of the thermoelectrically active material to the active form,
(K) if appropriate removing the support material, steps (I) to (K) being performable in any sequence.

Steps (F) to (K) of the process according to the invention for producing nanotubes are explained in detail below:

### Step (F):

Step (F) of the process according to the invention for producing nanotubes comprises the provision of a melt or solution which comprises at least one support material or suitable precursor compounds of the support material.

In a preferred embodiment, the support material is a polymer or a material which is obtained by the sol-gel process. In a particularly preferred embodiment, the support material is a polymer. When the support material is obtained by the sol-gel process, a solution of suitable precursor compounds is used in step (F).

In step (F) of the process according to the invention for producing nanotubes, the same support materials, preferably polymers, and solvents may be used as in step (A) of the process according to the invention for producing nanowires. Particular preference is given to using homo- and copolymers. Most preferably, the polymer is a polylactide or a polyamide.

The solution or the melt which comprises at least one at least one support material or suitable precursor compounds of the support material can be prepared by all processes known to those skilled in the art.

For the preparation of a solution and for the preparation of a melt comprising at least one support material, the same applies as was stated with regard to step (A) of the process according to the invention for producing nanowires. When a polymer is used, the concentration of the at least one polymer in the solution is generally at least 0.1% by weight, preferably from 1 to 30% by weight, more preferably from 2 to 20% by weight.

### Step (G):

Step (G) of the process according to the invention for producing nanotubes comprises the electrospinning of the melt or solution from step (F) to obtain a fiber of at least one support material.

The electrospinning process is known to those skilled in the art, for example from Adv. Mater. 2004, 16, No. 14, pages 1151-1169.

With regard to the electrospinning, the same applies as was stated for step (B) of the process according to the invention for producing nanowires, with the difference that a fiber comprising at least one support material is spun in step (G).

The electrospinning in step (G) can, if appropriate, be followed by washing and cleaning steps. In general, cleaning of the fiber obtained is not necessary.

The length of the fiber obtained in step (G) is in principle not restricted. By virtue of the continuous process, fibers of any length are obtainable.

In a preferred embodiment, the nanofiber produced is wound up on a drum. When the drum is covered at least once by the nanofiber over the entire width, the spinning operation can be interrupted, and the nanofibers can be cut through at right angles to the fiber and along the drum, so as to obtain a parallel arrangement of a multitude of nanofibers whose length corresponds to the circumference of the drum.

In a further preferred embodiment, instead of the drum, it is also possible to use a metal frame, onto which the fibers produced can be wound up. In this embodiment, a parallel arrangement of the fibers arises automatically. Such a procedure is disclosed, for example, in R. Dersch et al., J. Polym. Sci. Part A: Pol. Chem., Vol. 41, 545-553, 2003.

The thickness of an individual fiber obtained in step (G) is less than 200 nm, preferably less than 50 nm, more preferably less than 20 nm.

### Step (H):

Step (H) of the process according to the invention for producing nanotubes comprises the enveloping of the fiber obtained in step (G) with at least one thermoelectrically active material or a precursor of a thermoelectrically active material to obtain a fiber comprising at least one support material and at least one thermoelectrically active material or a precursor compound of a thermoelectrically active material.

The enveloping of the fiber obtained in step (G) with at least one thermoelectrically active material or a precursor of a thermoelectrically active material can be carried out by all processes known to those skilled in the art.

The fiber obtained in step (G) can be enveloped, for example, by gas phase deposition, sputtering, spin-coating, dip-coating, spraying or plasma deposition. Preference is given to enveloping by gas phase deposition.

With regard to suitable thermoelectrically active materials or precursor compounds of thermoelectrically active materials, the same applies as was stated for step (A) of the process according to the invention for producing nanowires.

In the process for preparing nanotubes, the thermoelectrically active material used is more preferably bismuth.

In the context of the present invention, enveloping means that the fiber obtained in step (H) is enveloped by at least one thermoelectrically active material or by a precursor compound of the thermoelectric material to an extent of at least 50%, preferably to an extent of at least 80%, more preferably to an extent of at least 90%.

Step (H) of the process according to the invention for producing nanotubes may generally also comprise washing and cleaning steps of the enveloped fibers. In a preferred embodiment, no washing and cleaning steps are carried out.

The thickness of the layer of at least one thermoelectrically active material or of a precursor compound of a thermoelectrically active material applied to the fiber in step (H) is generally from 1 nm to 100 nm, preferably from 5 nm to 30 nm.

In step (H) of the process according to the invention for producing nanotubes, a fiber is obtained which comprises at least one support material and which is enveloped by a layer of a thermoelectrically active material or of a precursor compound of the thermoelectrically active material.

### Step (I):

The optional step (I) of the process according to the invention for producing nanotubes comprises the enveloping of the fiber obtained with an electrical nonconductor to obtain an electrically insulated fiber.

With regard to the enveloping with an electrical nonconductor, the same applies as was stated for step (C) of the process according to the invention for producing nanowires.

To envelop the nanofibers obtained in step (H) which comprises at least one support material, preferably at least one polymer, and at least one thermoelectrically active material or a precursor compound of a thermoelectrically active material, the thermoelectrically active material or a precursor compound enveloping a nanofiber of at least one polymer as an outer layer, all processes known to those skilled in the art may be used.

The electrical nonconductor is preferably applied to the fiber by gas phase deposition.

The electrical nonconductor used is more preferably poly(p-xylylene) or polytetrafluoroethene.

When the optional step (I) is not carried out, the process according to the invention affords a nanotube which is not electrically insulated on the exterior.

### Step (J):

The optional step (J) of the process according to the invention for producing nanotubes comprises the conversion of the precursor compound of the thermoelectrically active material to the active form.

With regard to the conversion of the precursor compound of the thermoelectrically active material to the thermoelectrically active material, the same applies as has already been stated for step (D) of the process according to the invention for producing nanowires.

The optional step (J) has to be carried out only when a precursor compound of the thermoelectrically active compound is applied in step (H) to the fiber from step (G). When the thermoelectrically active material is applied to the fiber in step (H), step (J) can be dispensed with.

When a salt of the thermoelectrically active material is applied to the fiber in step (H), step (J) is carried out in this embodiment.

### Step (K):

The optional step (K) of the process according to the present invention for producing nanotubes comprises the removal of the support material, preferably of the polymer. When step (K) is not carried out, the process according to the invention affords nanotubes which are filled with support material.

With regard to the removal of the support material in step (K) of the process according to the present invention for producing nanotubes, the same applies as has already been stated for step (E) of the process according to the invention for producing nanowires.

In general, the support material, preferably the polymer, is removed in step (K) to an extent of at least 30%, preferably to an extent of at least 50%, more preferably to an extent of at least 70%.

In a preferred embodiment, the support material is removed by solvent extraction. In general, it is possible for this purpose to use all solvents and solvent mixtures which readily dissolve the support material which has been used in step (F) but poorly dissolve the electrical nonconductor which is, if appropriate, applied in step (I).

The nanotube has a diameter of less than 200 nm, preferably less than 50 nm, more preferably 20 nm, a wall thickness of less than 20 nm, preferably less than 10 nm, and a length of at least 1 mm, preferably at least 10 mm, more preferably at least 100 mm. Owing to the continuous process, the length of the nanotube is not restricted.

Steps (I), (J) and (K) can be carried out in any sequence. In a preferred embodiment, steps (I), (J) and (K) are carried out in the sequence (I), (J), (K).

The present invention also relates to a nanowire comprising at least one thermoelectrically active material and having a diameter of less than 200 nm, preferably less than 50 nm, more preferably less than 20 nm, and a length of at least 1 mm, preferably at least 10 mm, more preferably at least 100 mm.

The present invention also relates to nanotubes comprising at least one thermoelectrically active material and having a diameter of less than 200 nm, preferably less than 50 nm, more preferably 20 nm, a wall thickness of less than 20 nm, preferably less than 10 nm, and a length of at least 1 mm, preferably at least 10 mm, more preferably at least 100 mm.

The present invention also relates to the use of the inventive nanowires or nanotubes for thermoelectric heating, for electricity generation, in sensors, in telecommunications or for temperature control.

Examples of sensors are CCD arrays, gas sensors, sensors on semiconductor units or on CPUs.

Examples of thermoelectric heating are heaters, auxiliary heaters, air conditioning units.

An advantage of temperature control with the aid of the inventive nanowires and/or nanotubes is that they very precise temperature control is possible. Moreover, such a temperature control system reacts very rapidly and precisely.

Examples of use in electricity generation are heating by combustion of fossil fuels such as coal, mineral oil, natural gas or wood, by catalytic combustion, by waste heat or by the sun. In this case, the heating of the inventive nanowires or nanotubes in the abovementioned ways generates an electrical current by means of the thermoelectrically active materials in the nanowires or nanotubes.

The analysis of the inventive nanowires or nanotubes for experimental or application purposes can be carried out by all processes and methods known to those skilled in the art.

### EXAMPLES

### Example 1

### Production of Nanotubes

### The Template Used for the Bismuth Nanotubes is Electrospun PA66 Fibers:

### Fiber Production:

A solution of 15% m/m PA66 in formic acid (p.a. 98-100%) is spun. The spinning is effected from a PE syringe with a metal cannula (Ø 0.6 mm) onto a rotating aluminum roller with a diameter of 155 mm which rotates at a speed of 3500 rpm. The voltage applied is +22 kV on the syringe cannula against −2 kV on the roller (in each case relative to ground) at a cannula/roller separation of approx. 60 mm (electrical field strength E=400 kV/m). The propulsion for the syringe is adjusted appropriately, such that solution is available continuously at the cannula tip.

For better production of the fibers, either aluminum foil or PE film is applied to the roller, on which the fibers deposit. In order to ensure good removal of the fibers from the film, a plurality of layers of fibers have to be deposited. This entails at least a spinning time of from 15 to 30 min. The film or foil applied and comprising fibers is cut up at right angles to the roll. The fibers obtained thus have a length of approx. 487 mm.

### Vapor Deposition of the Bismuth Layer:

The fibers are removed from the film in a thin sheet and clamped in a brass holder of approx. 25×25 mm².

The vapor deposition is effected in a resistance vaporizer, the sample being mounted approx. 150 mm above the molybdenum boat comprising the molten bismuth beads. The brass holder is rotated about the axis along the fiber direction at approx. 20 rpm during the vapor deposition; the vapor deposition is effected with layer thickness control by means of a crystal oscillator. In order to achieve uniform coating, vapor deposition is effected with a very low rate of approx. 1-2 nm per min.

### Example 2

### Production of Nanowires by Incorporating Bi Salts in the Spinning

Production of poly-D,L-lactide/BiCl₃ Nanofibers:

A solution of 11% PDLLA/16.5% BiCl₃ (m/m) in acetone is spun. The spinning is effected from a PE syringe with a metal cannula (Ø 0.45 mm) onto a rotating aluminum roller (Ø 155 mm, 3500 rpm). The voltage applied is +13 kV on the syringe cannula against −2 kV on the roller (in each case relative to ground) at a cannula/roller separation of approx. 60 mm (electrical field strength E=250 kV/m). The propulsion for the syringe is adjusted appropriately, such that solution is available continuously at the cannula tip.

For better production of the fibers, PE film is applied to the roller, on which the fibers are deposited. In order to ensure good removal of the fibers from the film, a plurality of layers of threads have to be deposited. This entails at least a spinning time of from 10 to 20 min. The film applied and comprising fibers is cut up at right angles to the roller. The fibers obtained thus have a length of approx. 487 mm.

### Poly-para-xylylene Coating:

The coating is effected by the CVD process according to Gorham, a commercially available unit from “Speciality Coating Systems” SCS (Labcoater® 1, Parylene Deposition Unit Model PDS 2010) being used. The starting material used is [2,2]-paracyclophane. The monomer is evaporated at up to 175° C. and pyrolyzed to give quinodimethane at 650° C. Subsequently, the deposition/polymerization as a film onto the fibers is effected at a maximum pressure of 55 mbar and less than 30° C.

For coating, the fibers are wound onto metal frames in such a way that they are open to access from all sides as far as possible. In this procedure, 500 mg of monomer were weighed to obtain layer thickness approx. 250 nm.

### Polytetrafluoroethylene Coating:

The coating is effected by means of sputtering technology. The sputtering chamber is evacuated down to a pressure of 10⁻⁶ mbar and the plasma is then started (the pressure rises to approx. 10⁻³ mbar). The polytetrafluoroethylene target (Ø approx. 50 mm) is disposed approx. 50-60 mm away from the fiber sample. The fibers are clamped in a brass holder of approx. 25×25 mm² and rotate at 15 rpm about the axis along the fiber direction. The deposition is effected at a rate of approx. 5 nm/min (measured with crystal oscillator).

### Reduction to Metallic Bismuth:

The reduction is effected in a tubular oven which can conduct temperature ramps by means of a control unit. The program provides for three segments: heating (to 260° C. within 30 min), heat treatment (at 260° C. for 20 min), cooling (to RT for approx. 30 min.); the cooling proceeds more slowly than provided for by the oven control and depends upon the ambient conditions. Before the start of the reduction, the sample is evacuated in the tubular oven (approx. 0.1 mbar) and subsequently flushed with hydrogen; during the duration of the reduction, a gentle hydrogen stream is passed continuously over the sample (approx. 5 ml/min).

Reduction to Metallic Bismuth with Subsequent Removal of the PDLLA Core Fiber:

For this purpose, 5 segments are provided for: heating (up to 260° C. for 30 min), heat treatment (at 260° C. for 20 min), heating (to 270° C. for 10 min), heat treatment (at 270° C. for 5 h), cooling (to RT for 30 min); the cooling proceeds more slowly than provided for by the oven control and depends upon the ambient conditions.

Before the start of the reduction, the sample in the tubular oven is evacuated (approx. 0.1 mbar) and then flushed with hydrogen; during the duration of the reduction, a gentle hydrogen stream is passed continuously over the sample (approx. 5 ml/min).

During the heating to 270° C., the gas supply/purge is switched to protective gas (argon) and the oven is subsequently evacuated, so that a pressure of approx. ≦0.5 mbar is applied during the subsequent heat treatment operation.

### Example 3

### Production of Nanowires by Incorporating Bi Particles in the Spinning

### Production of Bi Nanoparticles:

The production is effected under argon atmosphere.

A clamped Schlenk vessel is initially charged with 25 mmol of sodium hydride NaH which are degassed and washed twice with absolute tetrahydrofuran THF, then 20 ml of THF are added and the mixture is heated to 65° C. 10 mmol of tert-butanol in 5 ml of THF are added and the suspension is stirred for a certain time. With vigorous stirring, 5 mmol of finely pulverulent BiCl₃ are added (all at once) and the solution is kept at 65° C. for a half hour. Directly after addition, the solution begins to turn black. Subsequently, the solution is cooled to RT and 20 ml of absolute THF are added, and the mixture is left to stir overnight and concentrated by rotary evaporation. A black powder remains which has particles approx. 5 nm in size under the electron microscope.

Production of poly-D,L-lactide/Bi Nanofibers:

A solution of 4% PDLLA/4% Bi particles (m/m) in dichloromethane is spun. The spinning is effected from a PE syringe with a metal cannula (Ø 0.45 mm) onto a rotating aluminum roller (Ø 155 mm, 3500 rpm). The voltage applied is +13 kV on the syringe cannula against −2 kV on the roller (in each case relative to ground) at a cannula/roller separation of approx. 60 mm (electrical field strength E=250 kV/m). The propulsion for the syringe is adjusted appropriately, such that solution is available continuously at the cannula tip.

For better production of the fibers, PE film is applied to the roller, on which the fibers are deposited. In order to ensure good removal of the fibers from the film, a plurality of layers of threads have to be deposited. This entails at least a spinning time of from 10 to 20 min. The film applied and comprising fibers is cut up at right angles to the roller. The fibers obtained thus have a length of approx. 487 mm.

### Removal of the PDLLA Core Fibers:

For this purpose, 3 segments are provided for: heating (up to 270° C. for 30 min), heat treatment (at 270° C. for 5 h), cooling (to RT for 30 min); the cooling proceeds more slowly than provided for by the oven control and depends upon the ambient conditions.

The tubular oven is evacuated before the start of the program, so that a pressure of approx. ≦0.5 mbar is applied over the course of the entire program.

What is claimed is:

1. A process for producing nanowires by treating a fiber comprising at least one support material and at least one thermoelectrically active material or a precursor compound of a thermoelectrically active material, comprising:
(A) providing a melt or solution which comprises at least one support material or suitable precursor compounds of the support material and at least one thermoelectrically active material or a precursor compound of a thermoelectrically active material,
(B) electrospinning the melt or solution from step (A) to obtain a fiber comprising at least one support material and at least one thermoelectrically active material or a precursor compound of a thermoelectrically active material,
(C) if appropriate enveloping the fiber obtained with an electrical non-conductor to obtain an electrically insulated fiber,
(D) if appropriate converting the precursor compound of the thermoelectrically active material to the active form,
(E) if appropriate removing the support material, steps (C) to (E) being performable in any sequence.

2. A process for producing nanotubes by treating a fiber comprising at least one support material and at least one thermoelectrically active material or a precursor compound of a thermoelectrically active material, comprising:
(F) providing a melt or solution which comprises at least one support material or suitable precursor compounds of the support material,
(G) electrospinning the melt or solution from step (F) to obtain a fiber of at least one support material,
(H) enveloping the fiber obtained in step (G) with at least one thermoelectrically active material or a precursor of a thermoelectrically active material to obtain a fiber comprising at least one support material and at least one thermoelectrically active material or a precursor compound of a thermoelectrically active material,
(I) if appropriate enveloping the fiber obtained with an electrical non-conductor to obtain an electrically insulated fiber,
(J) if appropriate converting the precursor compound of the thermoelectrically active material to the active form,
(K) if appropriate removing the support material, steps (I) to (K) being performable in any sequence.

3. The process according to claim 1 or 2, wherein the support material is a polymer or a material which is obtained by the sol-gel process.

4. The process according to claim 3, wherein the polymer is a polylactide or a polyamide.

5. The process according to any of claims 1 to 4, wherein the thermoelectrically active material is at least one compound comprising at least one element selected from the group consisting of tellurium, antimony, silicon, boron and germanium, and/or is selected from the group consisting of oxides, skutterudites, clathrates and bismuth.

6. The process according to any of claims 1 to 5, wherein the precursor compound for the thermoelectrically active material is a salt or a complex of the thermoelectrically active material.

7. The process according to any of claims 1 to 6, wherein the thermoelectrically active material is selected from the group consisting of bismuth, Bi₂Te₃, PbTe and mixtures thereof.

8. The process according to any of claims 1 to 7, wherein the electrical non-conductor is selected from the group consisting of aromatic and aliphatic homo- and copolymers and mixtures thereof.

9. The process according to claim 8, wherein the electrical nonconductor is poly-para-xylylene or polytetrafluoroethene.

10. A nanowire comprising at least one thermoelectrically active material and having a diameter of less than 200 nm and a length of at least 1 mm.

11. A nanotube comprising at least one thermoelectrically active material and having a diameter of less than 200 nm, a wall thickness of less than 30 nm and a length of at least 1 mm.

12. The use of nanowires according to claim 10 or nanotubes according to claim 11 for thermoelectric heating, for electricity generation, in sensors or for temperature control.
